(19) United States
(12) Patent Application Publication
(10) Pub. No.: US 2017/0066287 A1
(43) Pub. Date: Mar. 9, 2017

(54) Crown Reinforcement For Airplane Tire

(71) Applicants: COMPAGNIE GENERALE DES ETABLISSEMENTS MICHELIN, Clermont-Ferrand (FR); Michelin Recherche et Technique S.A., Granges-Paccot (CH)

(72) Inventor: Marc ROMERO DE LA OSA, Clermont-Ferrand Cedex 9 (FR)

(21) Appl. No.: 15/120,856

(22) PCT Filed: Feb. 23, 2015
(86) PCT No.: PCT/EP2015/053690

§ 371 Date: Aug. 23, 2016

(30) Foreign Application Priority Data
Feb. 24, 2014 (FR) 1451429

(51) Int. Cl. B60C 9/26; B29D 30/30; B60C 9/00; B29D 30/70

(52) U.S. Cl. CPC B60C 9/263; B29D 30/70; B29D 30/3035; B60C 9/0042; B60C 2200/02; B60C 2009/1828

(57) ABSTRACT

Aeroplane tire (1) comprises a working reinforcement (2) radially between tread (3) and carcass reinforcement (4). Working reinforcement (2) includes a working biply (21) comprised of the zigzag circumferential winding of strip (5) of width W onto a cylindrical laying surface (6) of radius R, with its axis of revolution being axis of rotation (YY′) of the tire, in a periodic curve (7) with period P and forming angle A with circumferential direction (XX′) of the tire in equatorial plane (XZ) of the tire. The winding of strip (5) comprises N periods P of curve (7) over T circumferences 2ΠR of surface (6). N is a whole number which satisfies the following conditions:
(a) N*(W/sin A)=2ΠR,
(b) N*P=2ΠR*T, where T is a whole number,
(c) N*T is the lowest common multiple of N and T,
   and the ratio T/N is at least equal to 1.8 and at most equal to 2.2.

The present invention relates to a tire for an aeroplane and, in particular, to an aeroplane tire crown reinforcement.

In what follows, the circumferential, axial and radial directions respectively denote a direction tangential to the tread surface of the tire in the direction of rotation of the tire, a direction parallel to the axis of rotation of the tire and a direction perpendicular to the axis of rotation of the tire. “Radially inside or, respectively, radially outside” mean “closer to, or, respectively, further away from, the axis of rotation of the tire”. “Axially inside or, respectively, axially outside” mean “closer to, or, respectively, further away from, the equatorial plane of the tire”, the equatorial plane of the tire being the plane passing through the middle of the tread surface of the tire and perpendicular to the axis of rotation of the tire.

In general, a tire comprises a tread intended to come into contact with the ground via a tread surface, the tread being connected by two sidewalls to two beads, the two beads being intended to provide mechanical connection between the tire and a rim on which the tire is mounted.

A radial aeroplane tire more particularly comprises a radial carcass reinforcement and a crown reinforcement, both as described, for example, in document EP 1381525.

The radial carcass reinforcement is the tire reinforcing structure that connects the two beads of the tire. The radial carcass reinforcement of an aeroplane tire generally comprises at least one carcass layer, each carcass layer being made up of reinforcers, usually textile, coated in a polymeric material of the elastomer or elastomer compound type, these reinforcers being mutually parallel and forming, with the circumferential direction, an angle comprised between 80° and 100°.

The crown reinforcement is the tire reinforcing structure radially on the inside of the tread and at least partially radially on the outside of the radial carcass reinforcement. The crown reinforcement of an aeroplane tire generally comprises at least one crown layer, each crown layer being made up of reinforcers that are mutually parallel and coated in a polymeric material of the elastomer or elastomer compound type. Among the crown layers, a distinction is usually made between the working layers that make up the working reinforcement and are usually made of textile reinforcers, and the protective layers, that make up the protective reinforcement, and are made of metal or textile reinforcers and arranged radially on the outside of the working reinforcement. The working reinforcement dictates the overall mechanical behaviour of the crown reinforcement, whereas the protective reinforcement essentially protects the working layers from attack likely to spread through the tread radially towards the inside of the tire.

The textile reinforcers of the carcass layers and of the crown layers are usually cords made up of spun textile filaments, preferably made of aliphatic polyamide or of aromatic polyamide. The mechanical properties under tension, such as the elastic modulus, the elongation at break and the force at break of the textile reinforcers, are measured after prior conditioning. “Prior conditioning” means that the textile reinforcers are stored for at least 24 hours, prior to measurement, in a standard atmosphere in accordance with European standard DIN EN 20139 (a temperature of 20±2° C., a relative humidity of 65±2%). The measurements are taken in the known way using a ZWICK GmbH & Co (Germany) tensile testing machine of type 1435 or type 1445. The textile reinforcers undergo tension over an initial length of 400 mm at a nominal rate of 200 mm/min. All of the results are averaged over ten measurements.

During the manufacture of an aeroplane tire and, more specifically, during the step of laying the working reinforcement, a working layer is usually obtained by zigzag circumferential winding or circumferential winding in turns of a strip onto a cylindrical laying surface having as its axis of revolution the axis of rotation of the tire. The strip is generally made up of at least one continuous textile reinforcer coated in an elastomeric compound and, most usually, of a juxtaposition of mutually parallel textile reinforcers. Whether created by zigzag circumferential winding or by circumferential winding in turns, the working layer is therefore made up of the juxtaposition of portions of strip.

What is meant by circumferential winding in turns of a strip is a winding of the strip, in the circumferential direction, and in a helix of radius equal to the radius of the cylindrical laying surface and at a mean angle, with respect to the circumferential direction, comprised between 0° and 5°. The working layer thus obtained by winding in turns is said to be circumferential because the angle between the textile reinforcers, pairs of which are mutually parallel, of the strip, formed in the equatorial plane, and the circumferential direction, is comprised between 0° and 5°.

What is meant by zigzag circumferential winding of a strip is winding of the strip, in the circumferential direction, and in a periodic curve, which means to say a curve made up of periodic undulations oscillating between extrema. Winding a strip in a periodic curve means that the mean line of the strip, equidistant from the edges of the strip, coincides with the periodic curve. During a zigzag circumferential winding of a strip, the working layers are laid in pairs, each pair of working layers constituting a working biply. Thus, a working biply is made up, in its main section, which means to say away from the axial ends thereof, of two radially superposed working layers. At its axial ends, a working biply generally comprises more than two radially superposed working layers. The number of additional working layers, in the radial direction, compared with the two working layers of the main section of the working biply are referred to as the axial end overthickness. This axial end overthickness is generated by the crossings of the strip, at the ends of the working biply, for each turn of zigzag winding. A working reinforcement such as this comprising working biplies obtained by zigzag circumferential winding of a strip has been described in documents EP 0540303, EP 0850787, EP 1163120 and EP 1518666.

The periodic curve of a zigzag circumferential winding is characterized by its amplitude and its period. The amplitude of the periodic curve, namely the distance between its extrema, measured in the axial direction, defines the axial width of the working biply, namely the distance between the axial ends of the working biply. More specifically, the axial width of the working biply is equal to the amplitude of the periodic curve, plus the width of the strip. The period of the periodic curve, measured in the equatorial plane of the tire, is such that the circumference of the cylindrical laying surface is usually a whole multiple of this period or of the corresponding half-period. Documents EP 2199108 and U.S. Pat. No. 5,730,814 describe relationships between the period of the periodic curve and the circumference of the cylindrical surface on which the strip is laid.

In the case of an aeroplane tire, the angle formed by the tangent to the periodic curve, in the equatorial plane, namely at the point at which the periodic curve intersects the equatorial plane, can adopt only a limited number of values, for a given amplitude of the periodic curve, which means to say for a given axial width of the working biply. By way of non-exhaustive examples, for an aeroplane tire of size 1400X530 R 23 having a working biply with an axial width of around 350 mm and laid on a cylindrical laying surface of radius equal to 650 mm, a period equal to the circumference of the cylindrical laying surface makes it possible to obtain an angle of the order of 10°, a period equal to half the circumference of the cylindrical laying surface makes it possible to obtain an angle of the order of 20°, and a period equal to one third of the circumference of the cylindrical laying surface makes it possible to obtain an angle of the order of 30°. This angle, which is also the angle formed by the textile reinforcers of the strip with respect to the circumferential direction, in the equatorial plane of the tire, is an important design parameter which dictates the various mechanical stiffnesses of the working biply and therefore those of the working reinforcement and this in particular impacts on the cornering stiffness of the tire. By definition, the cornering stiffness of the tire is equal to the torque that has to be applied in the radial direction of the tire in order to turn the tire, through an angle of rotation of 1° about the radial direction. Therefore, a restricted number of angle values that can be achieved by the numbers of periods commonly used, limits the options for optimizing the mechanical stiffnesses of the working reinforcement.

The inventors have set themselves the objective of increasing the number of possible values for the angle formed, with the circumferential direction of the tire, by the textile reinforcers of the zigzag-wound strip that makes up a working biply of the working reinforcement of an aeroplane tire, so as to be able to optimize the mechanical stiffnesses of the working reinforcement.

This objective has been achieved, according to the invention, by a tire for an aeroplane, comprising:
a working reinforcement radially on the inside of a tread and radially on the outside of a carcass reinforcement,
the working reinforcement comprising at least one working biply consisting of two radially superposed working layers,
the working biply consisting of the zigzag circumferential winding of a strip of width W onto a cylindrical laying surface of radius R, having as its axis of revolution the axis of rotation of the tire, in a periodic curve,
the periodic curve having a period P and forming an angle A with the circumferential direction of the tire in the equatorial plane of the tire,
the zigzag circumferential winding of the strip comprising N periods P of the periodic curve over a number T of circumferences 2ΠR of the cylindrical laying surface, the number N of periods P of the periodic curve being a whole number which satisfies the following conditions:
(a) N*(W/sin A)=2ΠR,
(b) N*P=2ΠR*T, where T is a whole number,
(c) N*T is the lowest common multiple of N and T,
   and the ratio T/N between the whole number T of circumferences 2ΠR of the cylindrical laying surface and the whole number N of periods P of the periodic curve which are needed to make up the working biply, being at least equal to 1.8 and at most equal to 2.2.

Each of the two working layers that make up the working biply is made up of the juxtaposition of N portions of strip, the strip having a width W and forming an angle A with the circumferential direction of the tire, in which N is the number of periods P of the periodic curve, which means to say the number of times that the strip laying path has to be repeated in order to create the working biply. Therefore, the developed circumferential length of a working layer is equal to N*(W/sin A), where W/sin A is the width of the strip projected onto the circumferential direction. The first condition N*(W/sin A)=2ΠR expresses the fact that the developed circumferential length of a working layer is strictly equal to the circumference 2ΠR of the cylindrical laying surface of radius R, namely that the juxtaposition of portions of strip is performed uniformly. What is meant when the juxtaposition of portions of strip is said to be uniform is that the juxtaposition contains no discontinuity or gap between two adjacent portions of strip, or contains no overlapping of two adjacent portions of strip.

The total length of strip, projected onto the circumferential direction, needed to create the working biply, is equal to N*P, where N is the whole number of periods P of the periodic curve and where P is the period of the periodic curve. The second condition N*P=2ΠR*T, where T is a whole number, expresses the fact that the total projected length of strip is equal to a whole multiple T of the circumference 2ΠR of the cylindrical laying surface of radius R. T represents the number of turns of winding of the strip onto the cylindrical laying surface of radius R that is required for creating the working biply. The fact that T is a whole number makes it possible to guarantee that the mechanical strength of the working biply is uniform in the circumferential direction. Specifically, if T is not a whole number, the working biply then contains, in the main section axially on the inside at its axial ends, zones made up of two radially superposed working layers and zones made up of more than two radially superposed working layers, therefore zones with different mechanical strengths, leading to non-uniform mechanical strength of the working biply.

The third condition “N*T is the lowest common multiple of N and T” expresses the fact that, in order to create a working biply of uniform thickness, it is necessary to have a specific arithmetic relationship between the whole number N of periods P of the periodic curve and the whole number T of turns of winding of the strip onto the cylindrical laying surface. If that condition is not met, the working biply then comprises zones comprising gaps due to the absence of strip, and zones comprising overthicknesses generated by crossings and therefore superpositions of portions of strip.

The combination of the three conditions makes it possible to create a working biply, by zigzag winding of a strip that forms, with the circumferential direction, a given angle A, i.e. makes it possible to keep control over the mechanical stiffnesses of the working biply, with a view to optimizing tire performance such as endurance or wear.

According to the invention, the ratio T/N between the whole number T of circumferences 2ΠR of the cylindrical laying surface and the whole number N of periods P of the periodic curve which are needed to make up the working biply, is at least equal to 1.8 and at most equal to 2.2. With a conventional circumferential winding in turns, the angle A, formed with the circumferential direction by the strip, is close to 0°. With a conventional zigzag circumferential winding, in which the period P of the periodic curve is equal to the circumference 2ΠR of the cylindrical laying surface, namely in which the ratio T/N is equal to 1, the angle A is close to 10°. A zigzag circumferential winding with a ratio T/N close to 2, makes it possible to obtain an angle A equal to approximately 5°, which leads to a low cornering stiffness of the tire which is often what is sought-after for an aeroplane tire.

It is also advantageous for the width W of the strip to be at least equal to 2 mm, preferably at least equal to 6 mm. The strip needs to have a minimal width value both for the technological feasibility of the strip and for minimal productivity of the step of laying the strip.

It is further advantageous for the width W of the strip to be at most equal to 20 mm, preferably at most equal to 14 mm. A maximum strip width value makes it possible to reduce the number of turns of winding of the strip on the cylindrical laying surface, that is required in order to create the working biply, thereby reducing the time needed to create the working biply and therefore improving on productivity.

The strip generally comprises reinforcers made of a textile material, preferably of an aliphatic polyamide. Specifically, textile reinforcers, particularly made of aliphatic polyamide such as nylon, have a relatively low mass in comparison with metal reinforcers, making it possible to make significant savings on the mass of the tire and therefore gaining in aeroplane payload.

Alternatively, the strip comprises reinforcers made of an aromatic polyamide. Reinforcers made of an aromatic polyamide such as an aramid indeed make it possible to obtain a good compromise between mechanical strength and mass.

According to another embodiment, the strip comprises reinforcers made up of a combination of an aliphatic polyamide and of an aromatic polyamide. Such reinforcers are generally referred to as hybrid reinforcers and offer both the technical advantages of nylon and those of aramid: mechanical strength, deformability under tension, and lightness of weight.

The invention also relates to a method of manufacturing an aeroplane tire, comprising a step of manufacturing a working reinforcement, in which the working biply is obtained by the zigzag circumferential winding of a strip of width W onto a cylindrical laying surface of radius R, having as its axis of revolution the axis of rotation of the tire, in a periodic curve, the periodic curve having a period P and forming an angle A with the circumferential direction of the tire in the equatorial plane of the tire, the zigzag circumferential winding of the strip comprising N periods P of the periodic curve over a number T of circumferences 2ΠR of the cylindrical laying surface, the number N of periods P of the periodic curve being a whole number which satisfies the following conditions:
(a) N*(W/sin A)=2ΠR,
(b) N*P=2ΠR*T, where T is a whole number,
(c) N*T is the lowest common multiple of N and T,
   and the ratio T/N between the whole number T of circumferences 2ΠR of the cylindrical laying surface and the whole number N of periods P of the periodic curve which are needed to make up the working biply, being at least equal to 1.8 and at most equal to 2.2.

The features and other advantages of the invention will be better understood with the aid of the following figures which have not been drawn to scale:

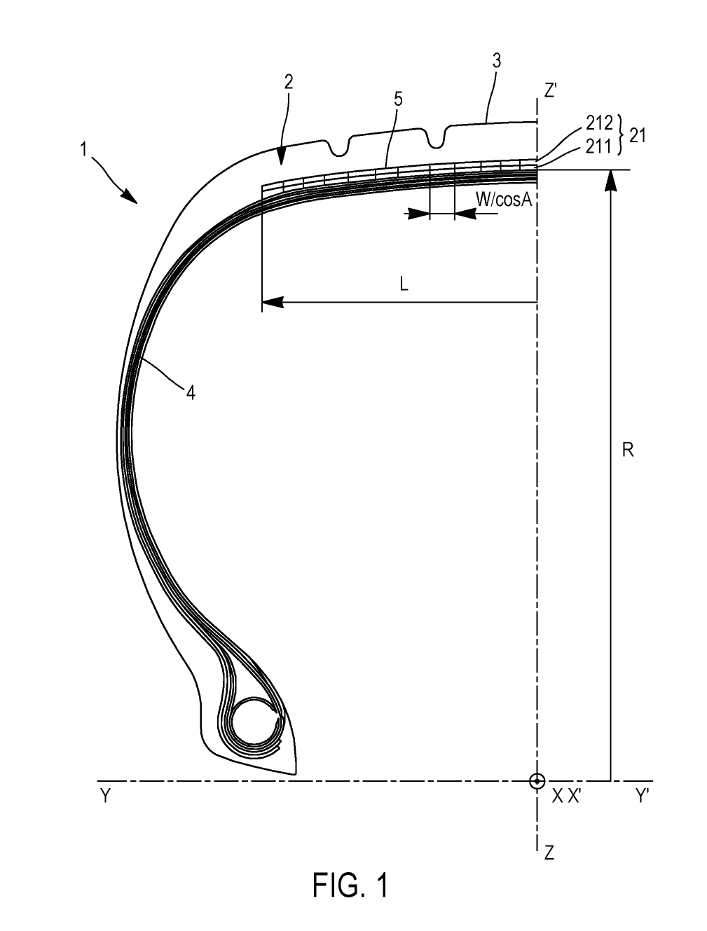

FIG. 1: a half view in cross section of an aeroplane tire according to the invention, in a radial plane (YZ) passing through the axis of rotation (YY′) of the tire.

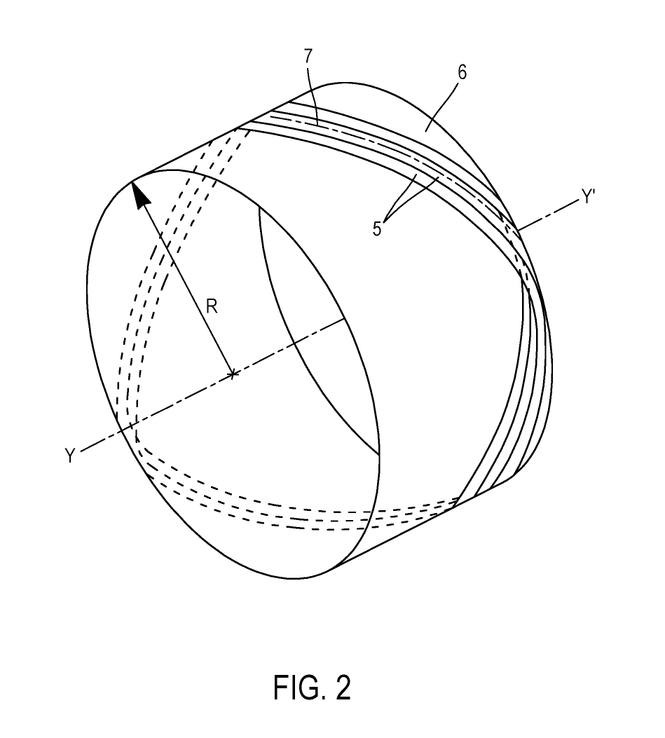

FIG. 2: a perspective view of a strip that makes up a working biply of a tire according to the invention, wound circumferentially in a zigzag in a periodic curve on a cylindrical laying surface.

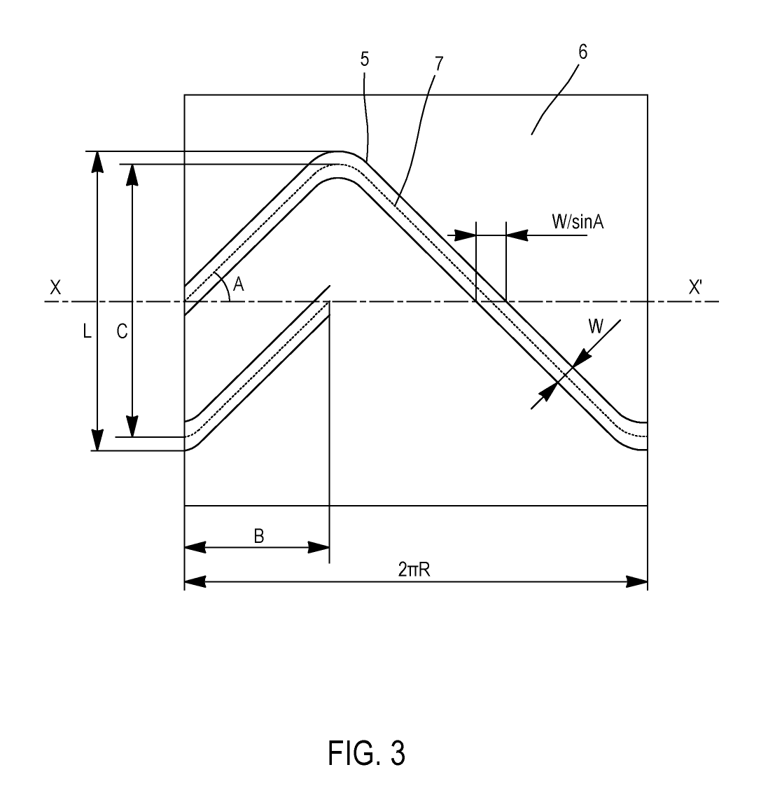

FIG. 3: a developed view of a strip that makes up a working biply of a tire according to the invention, wound circumferentially in a zigzag in a periodic curve, after the laying of one period.

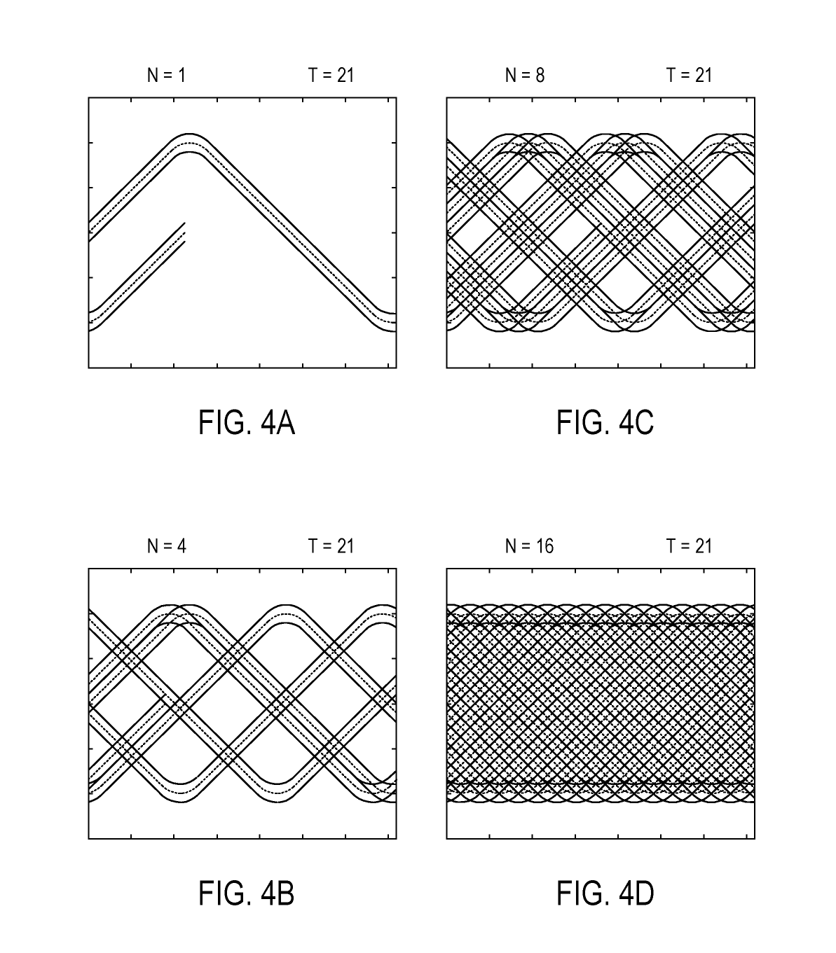

FIGS. 4A to 4D: developed views of a strip that makes up a working biply of a tire according to the invention, wound circumferentially in a zigzag in a periodic curve at various stages in the laying: after the laying of N=1 period (FIG. 4A), of N=4 periods (FIG. 4B), of N=8 periods (FIG. 4C) and of N=16 periods (FIG. 4D).

FIG. 1 depicts a half view in cross section, on a radial plane (YZ) passing through the axis of rotation (YY′) of the tire, of an aeroplane tire 1 comprising a working reinforcement 2 radially on the inside of a tread 3 and radially on the outside of a carcass reinforcement 4. The working reinforcement 2 comprises a working biply 21, made up at least in part of two radially superposed working layers (211, 212) and obtained by the zigzag circumferential winding of a strip of width W onto a cylindrical laying surface of radius R having as its axis of revolution the axis of rotation (YY′) of the tire. In a radial plane (YZ), each working layer (211, 212) is made up of an axial juxtaposition of portions of strip 5 of width W/cos A, where W is the width (not depicted) of the strip 5, measured perpendicular to the mean line of the strip 5, and A is the angle (not depicted) formed by the mean line of the strip 5 with respect to the circumferential direction (XX′) in the equatorial plane (XZ).

FIG. 2 is a perspective view of a strip 5 that makes up a working biply of a tire according to the invention, wound circumferentially in a zigzag in a periodic curve 7 onto a cylindrical laying surface 6 of revolution about the axis of rotation (YY′) of the tire, and of a radius R.

FIG. 3 is a developed view of a strip 5 that makes up a working biply of a tire according to the invention, wound circumferentially in a zigzag in a periodic curve 7 after the laying of one period. The strip 5 is laid on a cylindrical surface 6 of circumference 2ΠR, depicted in developed form. The mean line of the strip 5 follows a periodic curve 7, forming an angle A with the circumferential direction (XX′). The periodic curve 7 has a period P equal to 2ΠR+B, where B is the portion of period P beyond the circumference 2ΠR, and an amplitude C which, increased by two half-widths W/2 of the strip 5, namely by the width W of the strip 5, defines the width L=C+W of the working biply. The width of the strip 5, projected onto the circumferential direction (XX′), is therefore equal to W/sin A.

FIGS. 4A to 4D depict developed views of a strip that makes up a working biply of a tire according to the invention, wound circumferentially in a zigzag, in a periodic curve, at various steps in the laying, respectively after the laying of N=1 period (FIG. 4A), of N=4 periods (FIG. 4B), of N=8 periods (FIG. 4C) and of N=16 periods (FIG. 4D). The example depicted corresponds to the creation of a working biply by zigzag circumferential winding of a strip, the winding comprising N=16 periods P of the periodic curve over a number T=21 circumferences 2ΠR of the cylindrical laying surface of radius R. FIG. 4D depicts the developed view of the working biply fully formed, exhibiting a uniform appearance without gaps.

The inventors have carried out the invention for an aeroplane tire of size 1400X530 R 23 the working reinforcement of which comprises three superposed biplies, these respectively being radially inner, intermediate and radially outer, the geometric and laying characteristics of which are set out in Table 1 below:

TABLE 1

| | Working biply | | |
|---|---|---|---|
| | Radially inner | Intermediate | Radially outer |
| | biply | biply | biply |
| Axial width L (mm) | 370 mm | 347.3 mm | 321.5 mm |
| Strip width W (mm) | 11.4 mm | 11.4 mm | 11.4 mm |
| Angle A (°) | 5.1° | 4.8° | 4.5° |
| Period P (mm) | 8283 mm | 8330 mm | 8378 mm |
| Laying radius R (mm) | 649 mm | 652 mm | 655 mm |
| Laying circumference | 4076 mm | 4095 mm | 4113 mm |
| 2ΠR (mm) | | | |
| Number of periods N | 32 | 30 | 28 |
| Number of turns of | 65 | 61 | 57 |
| winding T | | | |
| Ratio T/N | 2.03 | 2.03 | 2.03 |

In the tire under investigation, the inventors, seeking to obtain three working biplies radially superposed from the inside towards the outside, having respective axial widths substantially equal to 370 mm, 350 mm and 320 mm, and comprising hybrid textile reinforcers forming an angle of approximately 5° with the circumferential direction, created the said working biplies by zigzag circumferential winding of a strip of width 11.4 mm, in which the ratio between the number T of circumferences 2ΠR of the cylindrical laying surface, or number of turns of winding, and the whole number N of periods P of the periodic curve needed to make up each working biply, is equal to 2.03, and therefore comprised between 1.8 and 2.2. The working biplies thus obtained meet the criterion of uniform thickness and therefore of uniform mechanical strength.

This invention is not restricted to the technical field of aeroplane tires but can also be applied to any tire comprising a crown reinforcement with at least one biply obtained by zigzag winding of a strip such as, for example and non-exhaustively, to a tire for a metro train. It can also be applied to a protective reinforcement where the latter comprises a biply obtained by zigzag winding of a strip.

1. A tire for an aeroplane, comprising:
a working reinforcement radially on the inside of a tread and radially on the outside of a carcass reinforcement;
the working reinforcement comprising at least one working biply comprised of two radially superposed working layers;
the at least one working biply comprised of a zigzag circumferential winding of a strip of width W onto a cylindrical laying surface of radius R, having as its axis of revolution the axis of rotation of the tire, in a periodic curve;
the periodic curve having a period P and forming an angle A with the circumferential direction of the tire in the equatorial plane of the tire;
the zigzag circumferential winding of the strip comprising N periods P of the periodic curve over a number T of circumferences 2ΠR of the cylindrical laying surface;
the number N of periods P of the periodic curve is a whole number which satisfies the following conditions:
(a) N*(W/sin A)=2ΠR,
(b) N*P=2ΠR*T, where T is a whole number,
(c) N*T is the lowest common multiple of N and T,
and the ratio T/N between the whole number T of circumferences 2ΠR of the cylindrical laying surface and the whole number N of periods P of the periodic curve which are needed to make up the at least one working biply, is at least equal to 1.8 and at most equal to 2.2.

2. The aeroplane tire according to claim 1, wherein the width W of the strip is at least equal to 2 mm.

3. The aeroplane tire according to claim 1, wherein the width W of the strip is at most equal to 20 mm.

4. The aeroplane tire according to claim 1, the strip being comprised of reinforcers coated in an elastomeric compound, wherein the strip comprises reinforcers made of a textile material.

5. The aeroplane tire according to claim 1, the strip being comprised of reinforcers coated in an elastomeric compound, wherein the strip comprises reinforcers made of an aromatic polyamide.

6. The aeroplane tire according to claim 1, the strip being made up of reinforcers coated in an elastomeric compound, wherein the strip comprises reinforcers made up of a combination of an aliphatic polyamide and of an aromatic polyamide.

7. A method of manufacturing an aeroplane tire according to claim 1, comprising a step of manufacturing the working biply, wherein the working biply is obtained by a zigzag circumferential winding of a strip of width W onto a cylindrical laying surface of radius R, having as its axis of revolution the axis of rotation of the tire, in a periodic curve, the periodic curve having a period P and forming an angle A with the circumferential direction of the tire in the equatorial plane of the tire, the zigzag circumferential winding of the strip comprising N periods P of the periodic curve over a number T of circumferences 2ΠR of the cylindrical laying surface, the number N of periods P of the periodic curve being a whole number which satisfies the following conditions:
(a) N*(W/sin A)=2ΠR,
(b) N*P=2ΠR*T, where T is a whole number,
(c) N*T is the lowest common multiple of N and T,
and the ratio T/N between the whole number T of circumferences 2ΠR of the cylindrical laying surface and the whole number N of periods P of the periodic curve which are needed to make up the working biply, being at least equal to 1.8 and at most equal to 2.2.

8. The aeroplane tire according to claim 1, wherein the width W of the strip is at least equal to 6 mm.

9. The aeroplane tire according to claim 1, wherein the width W of the strip is at most equal to 14 mm.

10. The aeroplane tire according to claim 1, the strip being comprised of reinforcers coated in an elastomeric compound, wherein the strip comprises reinforcers made of an aliphatic polyamide.
